(19) United States
(12) Patent Application Publication
(10) Pub. No.: US 2023/0132899 A1
(43) Pub. Date: May 4, 2023

(54) SCREEN PRINTING APPARATUS

(71) Applicant: Jessyca Cochran, Napa, CA (US)

(72) Inventor: Jessyca Cochran, Napa, CA (US)

(21) Appl. No.: 17/517,524

(22) Filed: Nov. 2, 2021

(51) Int. Cl. B41F 15/40

(52) U.S. Cl. CPC B41F 15/40

(57) ABSTRACT

A screen-printing apparatus for repeatedly marking an indicium at regularly spaced intervals or predefined discrete intervals on a surface or medium. The screen-printing apparatus includes a wheel mounted to a housing. A screen frame can be mounted to a housing that can interchangeably receive a screen having void(s) of a shape that corresponds to the indicia to be printed. The screen-printing apparatus also has an ink supplying unit that sprays ink over the top surface of the screen. A solenoid operably coupled to the ink supplying unit for triggering the ink supplying unit. The solenoid and the wheel are operably coupled to a control unit, the control unit can receive readings from the wheel about the distance covered by the wheel on the surface and based on the readings can trigger the solenoid at predefined intervals.

### CROSS-REFERENCE TO RELATED APPLICATIONS

This application claims priority to the U.S. provisional patent application Ser. No. 62/992,656, filed on Mar. 20, 2020, which is incorporated herein by reference in its entirety.

### FIELD OF INVENTION

The present invention relates to a screen-printing apparatus, and more particularly, the present invention relates to a screen-printing apparatus for printing indicia in spaced intervals on a medium.

### BACKGROUND

Printing an indicium on multiple objects or multiple times on the same object at spaced intervals is a common practice. This can be done for a number of purposes including branding, decoration, identification, and the like. Stamping is a common method for embossing an indicium on multiple objects. However, printing by repetitive stamping on a surface of an object may often result in the nonuniform application of indicia. Measuring the exact position for stamping on the object may be laborious and time-consuming. Still, stamping by hand may produce uneven results.

Therefore, a desire is there for a printing apparatus for uniformly printing a pattern in spaced intervals on a surface.

Hereinafter, the term “ink” is interchangeably used with other terms “paint”, “colorant”, or similar dye.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a screen-printing apparatus for printing indicia on regularly spaced intervals on a print receiving surface.

It is another object of the present invention that the screen-printing apparatus is a handheld instrument.

It is still another object of the present invention that the screen-printing apparatus is compact and portable.

It is yet another object of the present invention that the screen-printing apparatus is economical to manufacture.

It is a further object of the present invention that the screen-printing apparatus provides for uniform printing of an indicium on regularly spaced intervals or discrete intervals.

It is still a further object of the present invention that the screen-printing apparatus provides a faster application of the prints.

It is an additional object of the present invention that the screen-printing apparatus is easier to operate.

It is still an additional object of the present invention that the screen-printing apparatus provides an accurate and quick repetitive application of the same mark in discrete intervals.

In one aspect, disclosed is a handheld screen-printing apparatus for repetitive application of an indicium on a surface at regularly spaced intervals or predefined discrete intervals quickly and uniformly. The screen-printing apparatus includes a wheel of suitable diameter having a shaft traversing the center of the wheel. The shaft is rotatably mounted to a housing, wherein at least a bottom portion of the wheel is protruded from the housing. An elongated handle coupled to the housing, wherein the handle can be grabbed by a hand for moving the screen-printing apparatus on a surface, the periphery of the bottom of the wheel in contact with the surface. A control unit can be mounted on the housing and the control unit can have a user interface for receiving a configuration/instruction. A digital encoder coupled to the housing and can measure the angular rotation distance of the wheel. A screen frame mounted to the housing, the screen frame can interchangeably receive a screen. The screen has one or more voids that form the shape of the indicia to be printed. The screen frame can be positioned on the housing, such as to be in spatial relationship with a surface and when the ink is sprayed on an upper surface of the screen, the ink passes through the voids in the screen forming the Indicium on the surface. In one case, the frame can be moved up and down relative to the medium. The screen-printing apparatus further includes an ink supplying unit having one or more nozzles positioned to spray the ink on the upper surface of the screen. The ink can be ink, colorant, or paint. The ink supplying unit can be aerosol paint. A solenoid can be mounted on the housing and operable coupled to the ink supplying unit for triggering the spray of ink.

These and other objects and advantages of the embodiments herein and the summary will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a perspective view of the screen-printing apparatus, according to an exemplary embodiment of the present invention.

FIG. 2 is another perspective view of the screen-printing apparatus showing the digital encoder, according to an exemplary embodiment of the present invention.

FIG. 3 is an exploded view of the screen-printing apparatus, according to an exemplary embodiment of the present invention.

FIG. 4A shows the screen, according to an exemplary embodiment of the present invention.

FIG. 4B shows another exemplary embodiment of the screen, according to the present invention.

FIG. 4C shows another exemplary embodiment of the screen, according to the present invention.

FIG. 4D shows an indicium printed by the disclosed screen-printing apparatus, according to an exemplary embodiment of the present invention.

FIG. 5 shows an exemplary embodiment of the interface for configuring the marking positions, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

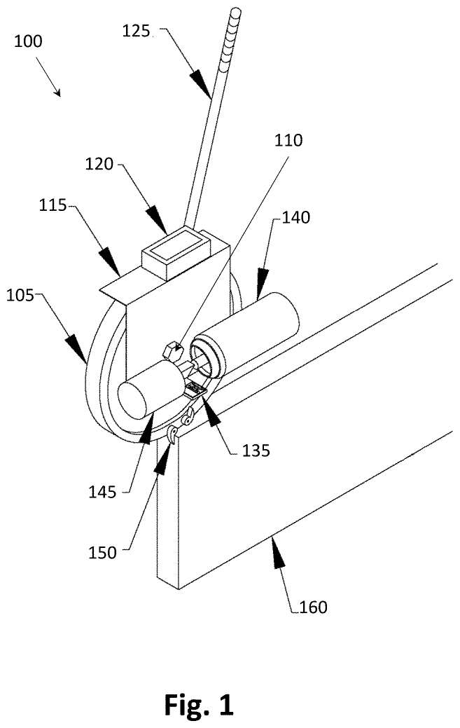

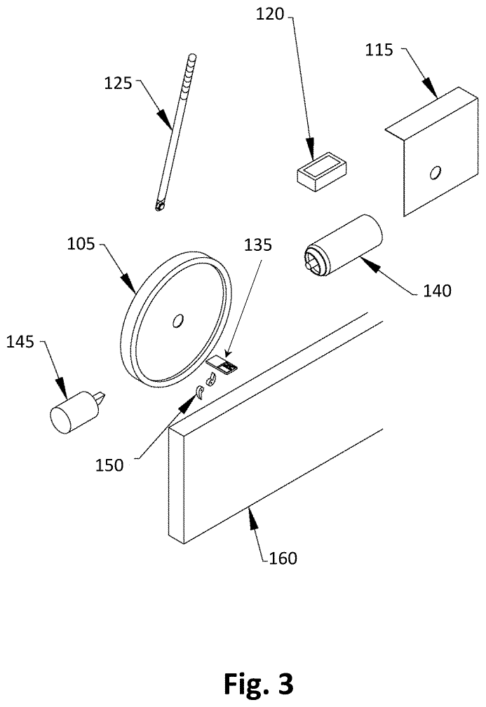

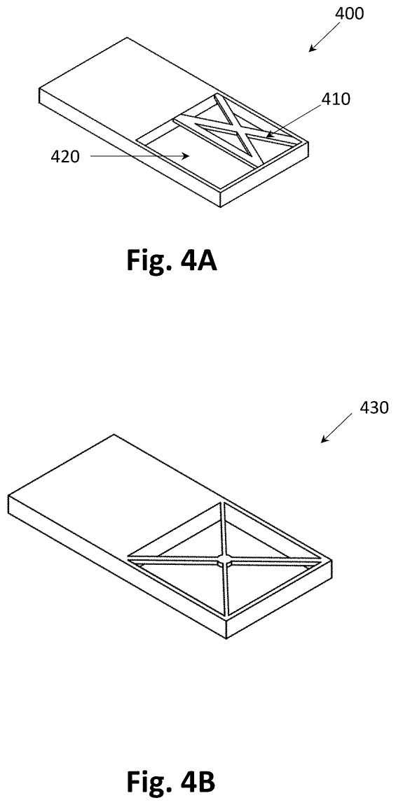

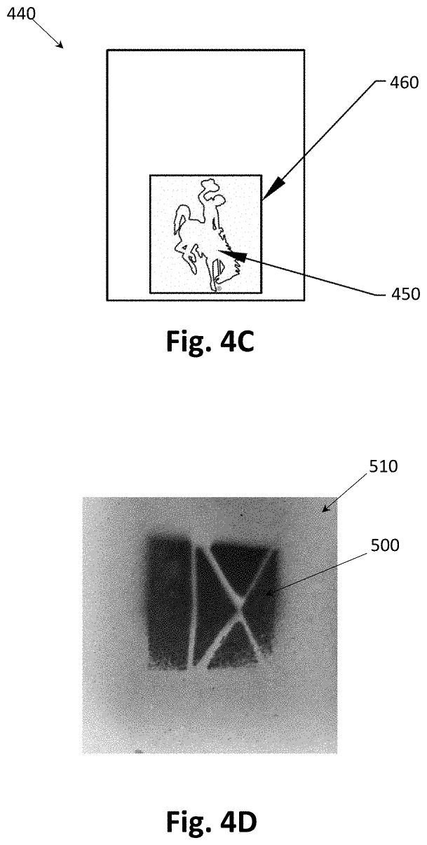

Disclosed is a screen-printing apparatus for applying a repetitive pattern or indicia at regularly spaced intervals or predefined discrete intervals on a surface, such as the surface of a paper, cardboard, cloth, board, and the like. Referring to FIGS. 1, 2, and 3 which shows an exemplary embodiment of the disclosed screen-printing apparatus 100. The screen-printing apparatus 100 can be a handheld apparatus that can be easily operated by a user for applying uniform indicium on a medium at regularly spaced intervals. The screen-printing apparatus 100 can include a wheel 105 of a suitable diameter. The diameter can be based on the medium and the interval distance. A wheel with a small diameter can be useful for the application of indicia in close intervals, while a larger wheel can cover more distance per rotation and can be faster in use. The wheel can be made of plastic material that is light in weight. The periphery of the wheel can be made of the same material as the wheel. Alternatively, the outer periphery of the wheel can have a layer of rubbery material for grip on the surface on which the wheel is moved. Additionally, ribs can also be provided for enhanced traction of the surface. The surface can be a surface of an object on which printing has to be done. It can be a roll of labels, cards, packaging, board, cloth, and the like. The indicia or pattern can be any mark, image, and the like that can be printed on a surface for identification, scaling, branding, or decoration of the object, and the like purposes. FIG. 4D shows an exemplary embodiment of the indicium printed by the disclosed screen-printing apparatus 100.

A shaft 110 can traverse through the center of the wheel 105 as shown in FIG. 1. The shaft 110 can be integrated with the wheel 105 or the wheel 105 can be rotatably mounted on the shaft 110. A housing 115 can be seen coupled to the shaft 110 wherein the housing 115 covers the top of the wheel 105. The bottom of the wheel is open and can contact the surface. The housing can cover any portion of the wheel but allow the bottom periphery of the wheel to be open for contact with a surface, such as the surface on which print has to be made. The wheel can rotate freely relative to the housing. In case, the wheel is rotatably mounted to the shaft, the shaft can be fixedly coupled to the housing. In case, the wheel and the shaft are fixed, the shaft can be rotatably mounted to the housing.

On top of the housing can be seen a control unit 120 that may include a microprocessor. The control unit 120 can also include a user interface for interacting with the user. The user interface can be a screen with buttons on it that allow the user to input parameter requirements for the operation of the screen-printing apparatus, such as setting the increment spacing and zeroing the measurement. The user can provide configuration, such as intervals at which the print has to be made, calibration of the wheel, setting the starting point, and the like. The user can also program a sequence of printing indicia, wherein all the intervals may or may not be the same. The user can program a sequence of applying the pattern, such as the first print when the wheel completes one round and the next print when the wheel completes two rounds. The sequence may be repeated, for example when a pattern has to be made on continuous objects, such as a roll of packaging. One sequence of repeatedly printing the mark at discrete intervals can be defined for one packaging, and the sequence can be repeated on subsequent continuous packaging in the roll. The user interface can also be a separate user device, such as a smartphone that can wirelessly connect to the control unit.

An elongated bar 125 can be seen that extends upwards at an angle from the housing. Bar 125 has a proximal end and a distal end. The proximal end of the bar can be coupled to the housing using a fastener, such as a nut and a bolt. Alternatively, the bar can also be welded to the housing. The distal end of the bar can have a handle that can be grabbed by a hand for operating the disclosed screen-printing apparatus. The bar is extended at an acute angle rearward, such as a user can grab the handle and push the assembly forward, wherein the wheel rotates on the surface forward without significant slip.

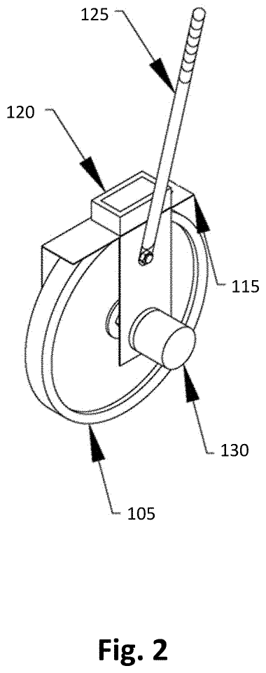

A digital encoder 130 (shown in FIG. 2) can also be provided for measuring the rotation of the wheel. The digital encoder 130 can be fixedly coupled to the housing and operably coupled to the wheel or the shaft. The Digital Encoder can measure the incremental rotation of the wheel along with the surface on which the wheel moves. The digital encoder can be operably coupled to the control unit, wherein the control unit can receive the reading taken by the digital encoder. The control unit can include the information related to the wheel, such as the diameter of the wheel, and can convert the angular distance covered by the wheel to the linear distance covered by the wheel on the surface.

The screen-printing apparatus may also include a screen assembly 135 mounted to the housing. The screen assembly 135 may include a screen frame that can be mounted to the housing. The screen frame can interchangeably receive a screen for printing. An exemplary embodiment of the screen can be seen in FIGS. 4A, 4B, and 4C. FIG. 4A shows screen 400 having a solid portion 410 and void portion 420. The shape of the void portion 420 can be the shape of indicia to be printed. For different patterns or shapes, different screens can be interchangeably used. Ink can be sprayed on the top surface of the screen, wherein the ink passes through the void and is applied over the surface. The position of the screen can be such that the ink sprayed of the upper surface of the screen can reach the surface through the voids in the screen without significant fade or distortion. It is preferable that while moving the screen-printing apparatus over the medium, the screen may be substantially parallel to the medium. In one case, the position of the screen frame and thus the screen can be adjusted, for example, the screen frame can be moved closer and farther from the surface. FIG. 4D shows a printed indicium 500 on a surface 510 printed using the screen 400 shown in FIG. 4A and using the screen with the disclosed screen-printing apparatus 100.

FIG. 4B shows another screen 430 having a similar indicium. FIG. 4C shows screen 440 having a solid portion 460 and void 450. The void corresponds to a mark having a horse and rider. Such as a mark can be a brandmark that can be printed on articles for branding.

The ink can be supplied by an ink supplying unit 140 mounted to the housing 115 and positioned to be in a spatial relationship with the screen. The ink supplying unit 140 can be an aerosol canister having one or more nozzles. The nozzles can be positioned to spray the ink on the upper surface of the screen. One or more nozzles can be provided for uniform spraying of the ink over voids in the screen. The ink can be sprayed with sufficient force such that the ink can pass through the voids of the screen and prevent any droplet formation.

The ink supplying unit 140 can be operated through a solenoid 145 also coupled to the housing 115. The solenoid 145 can be operably coupled to the control unit 120, such as the control unit can actuate the solenoid 145 to trigger the ink supplying unit 140 for printing the indicia. The control unit 120 at the interval specified by the user can trigger the solenoid to activate the ink supplying unit for a predefined duration. The structure and functioning of a solenoid are known in the art. In one case, the solenoid 145, the screen assembly 135, and the ink supplying unit 140 can be collectively adjusted in position, such as moving up and down.

The screen-printing apparatus 100 may also include a wheel lock unit 150 that can be used to align the wheel 105 at the beginning of a surface to be measured that has a vertical edge at the beginning of the measurement such as a rim joist so that the wheel is ensured to start at zero without being minutely misaligned in the placement process. FIG. 1 shows the wheel lock unit 150 engaged with the medium 160 on which indicia must be printed. The wheel lock unit 150 can be switched between an engaged state and a disengaged state. The wheel lock unit 150 is coupled through a pivot joint that allows the wheel lock unit 150 to be pivot between the two states. In the engaged state, the wheel lock unit 150 can be moved downwards against a start edge of the board. The wheel lock can be used for objects that have a vertical edge like plyboards, tables, slabs, boards, and the like.

The screen-printing apparatus can be powered by batteries or can receive power from Mains AC power through an AC to DC adaptor. The battery can be an inbuilt rechargeable battery or a replaceable battery.

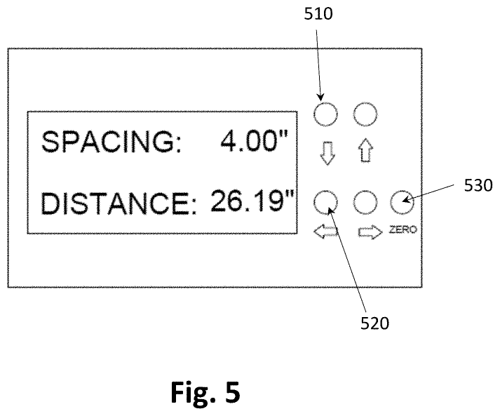

In one exemplary embodiment is disclosed a method of repeatedly printing an indicium at regularly spaced intervals or predefined discrete intervals using the screen-printing apparatus. First, the desired screen for the mark to be printed can be installed in the screen-printing apparatus. The spray paint canister can also be installed into the holder. Once the screen-printing apparatus is functional, the user can provide the interval parameter. The control unit can include some pre-set parameters that can be directly selected by the user. For example, the control unit can show two pre-set 16 inches and 24 inches in the center. Otherwise, the user can manually enter the value. The wheel locks can be engaged to mark the beginning. If not using the wheel locks, to set the beginning of the marker, place the wheel at the beginning of the interval to be marked and press “Zero Marker” on the user interface. FIG. 5 shows an exemplary embodiment of the user interface. The user can set the spacing and distance through the interface. Two buttons i.e., 510 for spacing and 520 for distance, can be provided for each setting the space and the distance. Actuating the “+” button can increment the value while the “−” button can decrement the value. Another button 530 can also be provided to set the zero mark. Zero mark can be set before starting the printing and resetting the distance traveled. If using the wheel locks, the wheel can be rotated to zero marker and the wheel locks can be engaged, and the “Zero Marker” option can be activated on the user interface. In case of stud placement, ¾″ subtraction may be desired and so the wheel can be rotated back to a ¾″ marker. The wheel can be set at the beginning of the measurement point using the wheel lock to align with the face of the material to be measured. Verify that distance measurement on the user interface is at zero (or −¾″). The wheel can then be rolled along the surface or medium to be marked being sure to roll the wheel linearly, such as in a straight line. At the chosen measurement increment, the spray canister can be triggered by the solenoid and a jet of ink can be sprayed on the upper surface of the screen which leaves a mark on the surface. The wheel can continue to roll, and the process can be repeated when the next interval is reached. Upon completion of the job, the apparatus can either be reset or turned off to ensure unintentional rotation of the wheel does not cause the spray of ink.

For the ¾ inches adjustment, two-wheel locks can also be provided. FIG. 1 shows two-wheel locks adjacent to each other. First, the front wheel lock can be engaged, and the distance can be reset by pressing the zero-marker button. Thereafter, the wheel can be repositioned by disengaging the front wheel lock and engaging the rear wheel lock providing the −¾ inches on center adjustment. The “wheel lock” can be used where the measurement begins at an element that has a vertical edge. FIG. 1 shows the rear wheel lock engaged to an edge of the board. The wheel lock works much like a ratcheting driver which only turns in one direction. When marking the layout of wall studs which are typically placed at 16 inches on center, the 4th stud would land at 48 inches from the beginning. The problem with that is that a sheet of plywood is 48 inches wide and the seam between two sheets needs to land at the center of a wall stud. Therefore, all the studs are pulled back ¾″ from the beginning (a stud is 1.5″ wide) so the sheet of plywood will land in the middle of the studs. The apparatus can be positioned at the edge of a rim board (the floor joist that sits under the wall studs) at the −¾″ location. For setting up the apparatus to use it to mark stud layout, set the wheel at the beginning of the rim board with the front wheel lock at the vertical edge to ensure the apparatus is properly aligned. Spacing i.e., 16″ o.c. can be selected and “zero marker” can be reset by pressing the zero button on the interface to make sure the interval was going to start at the right place. Thereafter, the wheel can be turned rearwards up to the rear wheel lock to ensure that the device was properly aligned and begin rolling the wheel down the board to mark at the defined intervals.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A screen-printing apparatus comprising:
a housing;
a wheel rotatably mounted to the housing, the wheel configured to roll on a surface;
a digital encoder mounted to the housing and operable coupled to the wheel, the digital encoder configured to measure rotations of the wheel;
a screen frame mounted to the housing, the screen frame configured to interchangeably receive a screen, the screen having one or more voids, the screen is positioned such as when ink is sprayed on a top surface of the screen, a portion of the ink passes through the one or more voids onto the surface forming an indicia;
an ink supplying unit coupled to the housing, the ink supplying unit has one or more nozzles in spatial relationship with the screen; and
a solenoid mounted to the housing and operably coupled to a control unit and the ink supplying unit, wherein the solenoid upon triggering by the control unit activates the ink supplying unit to spray the ink through the one or more nozzles on the top surface of the screen.

2. The screen-printing apparatus according to claim 1, wherein the screen-printing apparatus further comprises an elongated bar having a proximal end and a distal end, the proximal end of the elongated bar coupled to the housing, the distal end has a handle, the elongated bar extends upward and rearward to the housing.

3. The screen-printing apparatus according to claim 1, wherein the ink supplying unit is a pressurized aerosol paint mounted to a holder, wherein the holder is coupled to the housing.

4. The screen-printing apparatus according to claim 1, wherein the control unit is configured to:
receive one or more values of intervals at which the indicia have to be printed on the surface,
receive in near-real-time a reading of the digital encoder, the reading indicates values of an angle of rotation of the wheel,
trigger the solenoid when one or more values of intervals match the values of the angle of rotation of the wheel.

5. The screen-printing apparatus according to claim 1, wherein the screen frame is configured to be moved relative to the housing for adjusting a position of the screen frame relative to the surface.

6. The screen-printing apparatus according to claim 1, wherein the ink supplying unit, the solenoid, and the screen frame are configured to collectively move relative to the housing for manually adjusting their position relative to the surface.

7. The screen-printing apparatus according to claim 1, wherein the screen-printing apparatus further comprises a pair of wheel lock units coupled to a periphery of the wheel, each of the pair of wheel lock units configured to pivot between an engaged state and a disengage state, the pair of wheel lock units positioned at a predefined distance from each other.

8. A method of printing an indicia at regular intervals or predefined intervals, the method comprising the steps of:
providing a screen-printing apparatus comprising:
a housing,
a wheel rotatably mounted to the housing, the wheel configured to roll on a surface,
a digital encoder mounted to the housing and operable coupled to the wheel, the digital encoder configured to measure rotations of the wheel;
a screen frame mounted to the housing, the screen frame configured to interchangeably receive a screen, the screen has one or more voids, the screen is positioned such that when ink is sprayed on a top surface of the screen, a portion of the ink passes through the one or more voids onto the surface forming an indicia,
an ink supplying unit coupled to the housing, the ink supplying unit having one or more nozzles in spatial relationship with the screen, and
a solenoid mounted to the housing and operably coupled to a control unit and the ink supplying unit, wherein the solenoid upon triggering by the control unit activates the ink supplying unit to spray the ink through the one or more nozzles on the top surface of the screen;
receiving, through an interface, by the control unit, one or more values of intervals at which the indicia have to be printed on the surface; and
rolling the screen-printing apparatus on the surface.

9. The method according to claim 8, wherein the screen-printing apparatus further comprises an elongated bar having a proximal end and a distal end, the proximal end of the elongated bar coupled to the housing, the distal end has a handle, the elongated bar extends upward and rearward to the housing.

10. The method according to claim 8, wherein the ink supplying unit is a pressurized aerosol paint mounted to a holder, wherein the holder is coupled to the housing.

11. The method according to claim 8, wherein the screen-printing apparatus further comprises a pair of wheel lock units coupled to a periphery of the wheel, each of the pair of wheel lock units configured to pivot between an engaged state and a disengage state, the pair of wheel lock units positioned at a predefined distance from each other.

12. A method of printing an indicia at regular intervals or predefined intervals, the method comprising the steps of:
providing a screen-printing apparatus comprising:
a housing,
a wheel rotatably mounted to the housing, the wheel configured to roll on a surface,
a digital encoder mounted to the housing and operable coupled to the wheel, the digital encoder configured to measure rotations of the wheel,
a screen frame mounted to the housing, the screen frame configured to interchangeably receive a screen, the screen has one or more voids, the screen is positioned such that when ink is sprayed on a top surface of the screen, a portion of the ink passes through the one or more voids onto the surface forming the indicia
an ink supplying unit coupled to the housing, the ink supplying unit has one or more nozzles in spatial relationship with the screen, and
a stepper motor mounted to the housing and operably coupled to a control unit and the ink supplying unit, wherein the stepper motor upon triggering by the control unit activates the ink supplying unit to spray the ink through the one or more nozzles on the top surface of the screen;
receiving, through an interface, by the control unit, one or more values of intervals at which the indicia have to be printed on the surface; and
rolling the screen-printing apparatus on the surface.
